(19) United States
(12) Patent Application Publication
(10) Pub. No.: US 2016/0312896 A1
(43) Pub. Date: Oct. 27, 2016

(54) SEAL WITH ELASTIC LIPS

(71) Applicant: O.S.C. OFFSHORE SYSTEMS CONCEPTS, Aubagne (FR)

(72) Inventor: René PERRATONE, Menton (FR)

(73) Assignee: O.S.C. OFFSHORE SYSTEMS CONCEPTS, Aubagne (FR)

(21) Appl. No.: 15/103,327

(22) PCT Filed: Dec. 11, 2014
(86) PCT No.: PCT/FR2014/053299

§ 371 Date: Jun. 10, 2016

(30) Foreign Application Priority Data
Dec. 13, 2013 (FR) 1362632

(51) Int. Cl. F16J 15/3236; F16C 33/74

(52) U.S. Cl. CPC F16J 15/3236; F16C 33/74

(57) ABSTRACT

The invention concerns a seal, comprising two flexible lips cooperating with a heel and having, in a resting configuration, a U section, wherein the heel and the lips consist mainly of a chemically neutral and mechanically resistant thermoplastic polymer or of one of the derivatives thereof, and wherein the lips are arranged so as to be elastic. Preferably, polyetheretherketone is used.

This invention relates to the field of seals with elastic lips. These are used for all types of uses and preferably but not limited to implementation in rotating joints used to transmit fluid(s) between a fixed part and a rotating part.

An element performs a sealing function when it prevents the passage of a fluid from a first enclosure to a second neighbouring enclosure. Such elements are called “seals.”

Different types of sealing can be defined depending on the flow of the fluid whose passage is to be prevented, but also on the mechanical parts involved in this sealing.

Therefore, the expression single sealing is used if the flow of a fluid from a first enclosure into a second enclosure is to be prevented. If sealing is achieved in both directions, i.e the seal must prevent another fluid that may be contained in the second enclosure from flowing towards the first, sealing is said to be double. In the same way, sealing is said to be static if both parts, between which it is likely that a leak will occur, are fixed in relation to each other. The expression dynamic sealing is used if these two parts move in relation to each other. In practice, two types of relative, combinable, movement are mainly observed: linear translation, which can correspond, for example, to the relative sliding of a piston in a cylinder, and rotation which can be, for example, a relative rotation about a common axis of a shaft in a hub or a casing.

Seals may consist of different materials depending on their applications: leather, oakum in plumbing and mechanics, fibrin in valves and fittings and, felt, rubber, elastomers, polymers and metals such as alloy steel, brasses, nickel-silver, etc. The material of seals must withstand the difference in pressure and temperature of the fluid whose passage is to be prevented, as well as its chemical composition. Seals generally undergo natural ageing so must be replaced after a certain time. Lastly, a seal must be suited to different operating conditions, namely:
the type of use, whether for static or dynamic sealing;
the pressure exerted round the seal;
the nature of the fluid to be sealed;
the temperature of the fluid and surrounding environment;
the speed of the fluid whose passage is to be prevented;
the surrounding environment, for example the presence of a corrosive or explosive atmosphere, or the chemical compatibility between the seal and the fluid to be sealed;
the desired lifetime of the seal;
the tolerance of a leak, etc.

By way of a preferred but non-limiting application, we will describe systems that use dynamic sealing and more particularly seals for rotating shafts.

For this type of application, numerous devices are used, such as:
return baffles or turbines, also called lateral seal; they ensure sealing about an axis of rotation, between two perpendicular faces. These are frictionless seals that are not capable of forming the required seal when they are not in motion;
packing boxes: these are formed by packing made of fibrous material, such as oakum, and secured to the shaft by axial locking using a nut. Today, most of these have been replaced by lip seals or so-called “surface” seals. These have a high friction torque and absorb a relatively high power;
O-rings: annular in shape, made of synthetic elastomers, with a variable profile, they are often used as static seals. They cannot, however, be used as seals for shafts rotating a low speed;
lip seals for rotating shafts: when they appeared about fifty years ago, they consisted of a leather cuff whose lip was secured to the rotating shaft by a toroidal spring. Due to the presence of leather, their lifetime was short because leather offers poor resistance in particular to high temperatures. Leather has now been replaced by synthetic elastomers, such as, being a non-limiting example, nitrile (also known as “acrylonitrile butadiene”), a fluorocarbon elastomer such as polytetrafluoroethylene (also known by the abbreviation “PTFE”), polyacrylates or silcones.

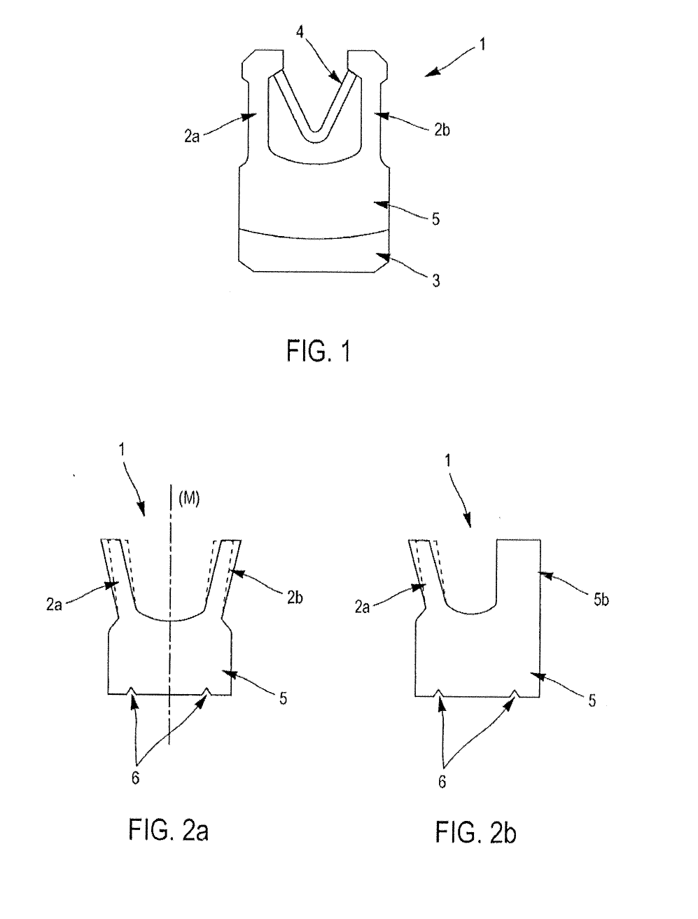

To guarantee dynamic sealing of rotating shafts with the aid of seals, preferably U-shaped seals combining different types of materials are used. An example of this type of seal is described in connection with FIG. 1. A seal 1, with a U-shaped profile, consists of four main components: two lips 2a and 2b, advantageously made of polytetrafluoroethylene (PTFE), cooperating with a heel 5, a spring 4, preferably but not limited to being flat and made of stainless steel, and an anti-extrusion ring 3 made of a suitable material, resistant to extrusion. Each of the said components plays a very specific role in the operation of the seal. The two lips 2a and 2b maintain the contact of the seal 1 with the groove of the said seal and the surface to be sealed and thus ensure sealing. Lips 2a and 2b follow the profile and the shape of the seal groove and the surface to be sealed. The heel 5 allows the cooperation and retention of the lips 2a and 2b with the rest of the seal 1: the said heel 5 and the lips 2a and 2b form a single entity. The material used to manufacture the lips 2a and 2b must possess particular physical and chemical properties: it must be chemically inert, i.e be capable of ensuring complete absence of chemical reaction between the material and the fluid to be sealed, have a low friction coefficient to prevent any premature wear, reduce rotational torque and have a good thermal resistance.

Usually, PTFE is therefore the material chosen to manufacture the lips 2a and 2b because:
it is practically inert in the presence of all known products (it can only be attacked by very specific chemical compounds, such as molten alkali metals, molten alkalis, by chlorine trifluoride or by fluorine in its elemental state);
it is one of the most physically and chemically stable thermoplastics materials. In fact, PTFE starts to decompose above 400° C.;
it has the lowest friction coefficient of all solid materials. In fact, its values lie between 0.05 and 0.09.

Nevertheless, PTFE has certain drawbacks: its very poor mechanical resistance or its great flexibility prevents it from exerting the necessary springback force to enable, for example, contact of the sealing lips with the surfaces to be sealed.

In order to overcome this drawback, the seal contains a spring: it is sealed between the two lips 2a and 2b and thus provides a radial force at the two lips 2a and 2b necessary to ensure sealing. In fact, sealing is created by the presence of a closed space, not allowing the fluid within this space to escape or not allowing fluids outside this space to enter therein. This space is almost always obtained with the aid of several parts which, placed in contact with each other, form a closed space. It is the lips 2a and 2b in contact with the groove or surface to be sealed that allows the formation of the said space. The spring 4 guarantees that the lips are held against the walls of the groove or the surface to be sealed. Several types of springs are used: preferably metal for this type of application, flat springs will be chosen.

Furthermore, PTFE is difficult and specific to shape: it cannot be transformed by melting like most thermoplastic polymers so it cannot be moulded with the aid of the existing conventional solutions. For this reason, the seals are formed by a sintering method. Sintering is a process of manufacturing parts that involves heating a granular powder without melting it. Under the effect of the heat, the grains of PTFE weld together, which forms the cohesion of the part. Faced with high pressures and significant increases in temperature, an extrusion phenomenon may develop at the seal and cause erosion of the seal 1 and consequently creep, i.e an irreversible distortion of the seal 1. The said seal 1 can then no longer perform its sealing function. In order to overcome this problem, an anti-extrusion ring 3 is associated with the seal 1. Its function is to allow the seal 1 to withstand the effects of extrusion. The said anti-extrusion ring 3 usually consists of a thermoplastic polymer type material other than PTFE, in order to avoid and prevent the recurrence of wear and extrusion problems.

However, despite all of the advantages that this type of seal 1 brings and all of the recommended solutions to remedy the various drawbacks imposed by certain characteristics, some difficulties are still not overcome or resolved:
firstly, several problems result from the use of the spring 4. As a first example, after long-time use or unsuitable conditions of use, the spring 4 can deteriorate or even break. The same applies if the fluid to be sealed is not suited to the material of the spring and causes corrosion reactions on the spring 4. These two situations can cause serious loss of the sealing function of the seal 1 because, due to the deterioration of the spring 4, it does not exert the radial force to be applied in order to ensure sealing;
other drawbacks relate to industrialisation: in certain applications, the seal 1 can have a considerable diameter, in the order of two metres. The manufacture of the seal 1, consisting of the three components which are the lips 2a and 2b, the spring 4 and the anti-extrusion ring 3, imposes significant constraints: care must be taken to assemble all of the components of the seal 1 correctly, which requires constant attention.
Moreover, for certain applications such as the use of seals for rotating joints in an offshore rig, the seal 1 may be in direct contact with the oil. This oil may contain sand which, in the case of a PTFE seal, can build up inside the seal, leading to erosion of the seal, creep and rapid wear. Consequently, the PTFE seal 1 is no longer capable of fulfilling its sealing function. Other factors, such as pressure and temperature, depending on the applications, can affect extrusion of the seal.

The invention overcomes most of the drawbacks raised by known solutions.

Among the many advantages of a seal according to the invention we can mention that it allows:
simplifying the manufacturing processes of the seal, enabling it to be made of one material and in one piece;
reducing industrialisation problems and problems relating to the presence of a spring;
increasing the lifetime of the seals, thanks in particular to using a composite material with exceptional physical and chemical properties, significantly reducing the problems of wear and erosion;
improving the tightness of the seal, thanks to choosing a material that has a very low friction coefficient, very good chemical inertia and good resistance to extrusion.

To this end, a seal is especially provided that comprises a first flexible lip cooperating with a heel and having, when said first lip is in a resting configuration, a U section.

In order to optimise the sealing performance of the seal as well as its lifetime and to simplify the manufacturing processes of said seal, the heel and the first lip of the seal according to the invention consist mainly of a chemically neutral and mechanically resistant thermoplastic polymer or of one of the derivatives thereof, and the said first lip is arranged in order to exert a springback force sufficient to recover the resting configuration.

Preferably, the U section of the seal according to the invention can comprise a second flexible lip arranged so as to exert a springback force sufficient to recover a resting configuration and the U section of the said seal can have a rotational symmetry in relation to the median plane (M) of the heel.

Advantageously, due to its exceptional physical and chemical properties, the thermoplastic polymer used to manufacture the seal according to the invention can be polyetheretherketone (henceforth referred to as PEEK).

Alternatively, the thermoplastic polymer used to make the seal according to the invention can advantageously be of polyamide-imide (henceforth referred to as PAI).

In order to ensure its use as a seal for swivel joints or devices, the seal may advantageously have an annular shape.

In order to achieve a seal contact pressure greater than the pressure of the fluid to be sealed and consequently ensure optimum sealing, the heel of said seal may also have one or more grooves arranged in the distal part of said heel opposite the lips.

To ensure sealing of rotating shafts using different assemblies such as “piston” or “face” assemblies, the lip or lips of the said seal may be in a radial position.

Alternatively, the lip or lips of the said seal may be in an axial position.

In order to ensure simplified production of the seal and optimise the sealing process, the heel and the lip or lips of said seal may form a single entity.

According to a second subject-matter, the invention concerns a process for the manufacture of a seal according to the invention. To enable seals of different diameters to be made, in particular quite large diameters such as two metres or more, the manufacturing process of a seal, including the lip or lips and heel as a single entity, may comprise a machining step of the said seal.

Alternatively or additionally, in order to make small-diameter seals and simplify the means of manufacture of said seals, the manufacturing process of a seal, including the lip or lips and the heel as a single entity, may comprise an injection-moulding step of the said seal.

According to a third subject-matter, the invention concerns a rotating joint, comprising a fixed part and a rotating part kept concentric by a mechanical bearing, a toroidal chamber formed between the said fixed and rotating parts, arranged to form a restricted passage of fluid. In order to optimise the operation of the rotating joint and ensure maximum sealing, more particularly in the context of offshore stations, the toroidal chamber contains at least one seal according to the invention.

According to a fourth subject-matter, the invention concerns a friction bearing. To guarantee both minimal wear of the parts comprising the rotating shaft and at the same time optimum sealing, the friction bearing advantageously comprises, at one of its ends, at least one seal according to the invention.

Further features and advantages will emerge more clearly from the following description and an examination of the accompanying Figures, in which:

FIG. 1, previously described, is a detailed view of a seal according to the known state of the art;

FIGS. 2a and 2b show a seal according to the invention;

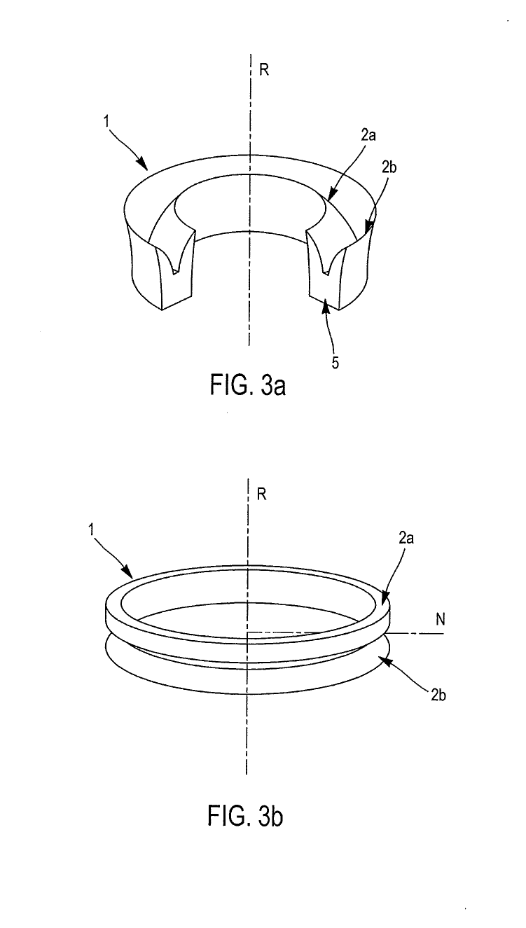

FIGS. 3a and 3b are a graphic representation of a seal with an axially and radially U-shaped profile;

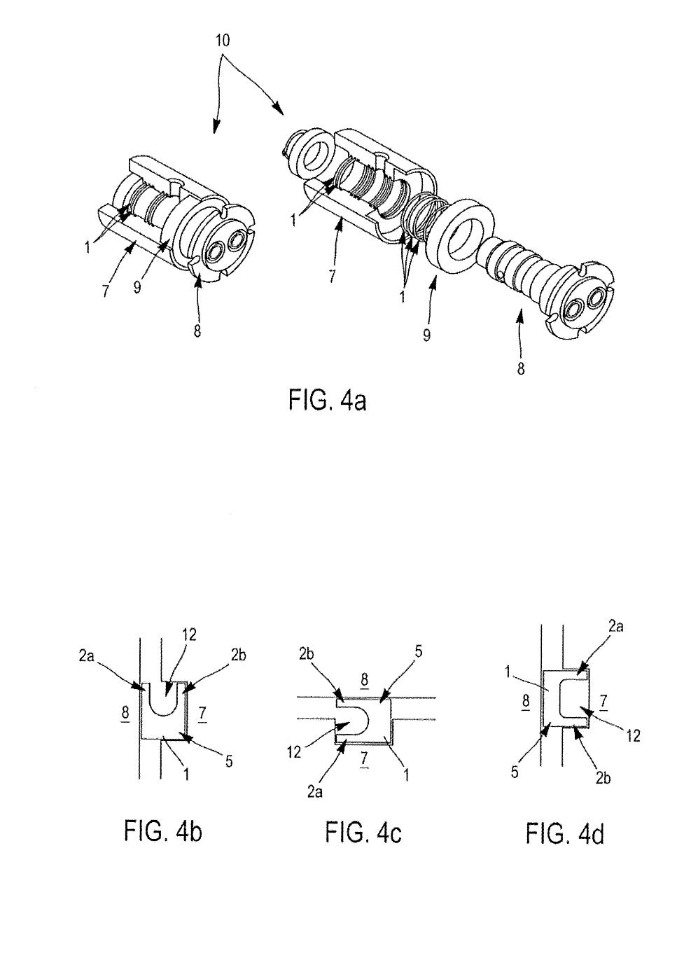

FIG. 4 is a schematic representation of a rotating joint according to the invention;

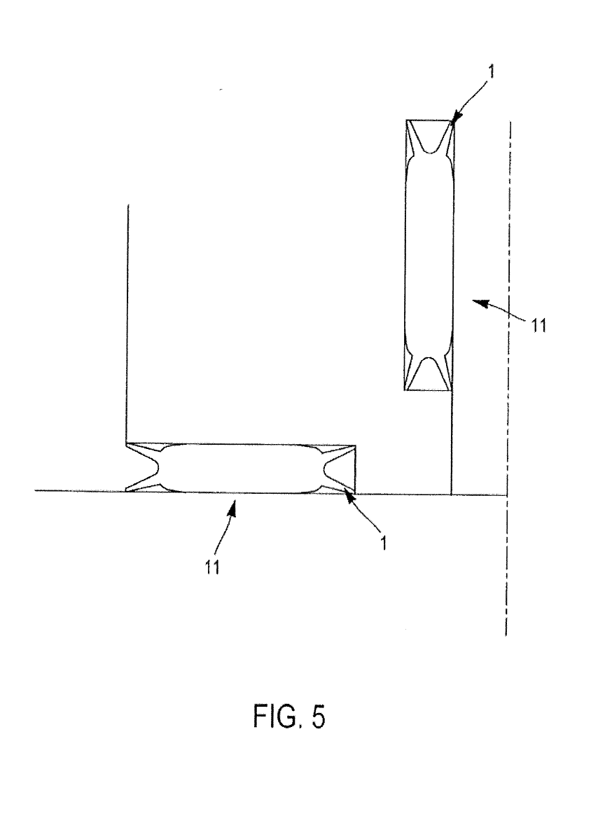

FIG. 5 is a variation of an embodiment of a friction bearing according to the invention.

FIGS. 2a and 2b are schematic representations of a seal according to the invention.

The seal 1 according to the invention forms a single entity and has a U-shaped profile, comprising one or more, preferably two lips 2a and 2b and one heel 5. In a preferred application, the seal 1 comprises two flexible lips, according to the example described in connection with FIG. 2a. The presence of one or more lips will depend on the sealing required. In the example described in connection with FIG. 2b, the lip 2a faces a projection 5b of the heel instead of lip 2b. Alternatively, the seal 1 according to the invention might have only one lip 2b facing a projection of the heel. Unlike the seal according to the state of the art described in relation to FIG. 1, the seal 1 according to the invention has no spring since the seal 1 is manufactured entirely of one specific material: a chemically neutral and mechanically resistant thermoplastic polymer or one of the derivatives thereof. A thermoplastic polymer is a macromolecular material whose main characteristic is its capacity for solid/liquid reversible transformation by heat. The intermediate state during said reversible transformation, when the polymer is melting, enables the deformation of the said thermoplastic polymer under the action of mechanical stresses, this deformation being fixed by cooling. A derivative means any charged thermoplastic polymer corresponding to the definition of the same nature or charged resin of said polymer. The thermoplastic polymer must have specific physiochemical properties: it must be chemically inert, that is, capable of guaranteeing the complete absence of chemical reaction between the material and the fluid to be sealed in order to avoid any extrusion or deterioration of the material, and mechanically resistant. Mechanically resistant means not only the fact that the material must possess a very low friction coefficient in order to avoid any premature wear of the seal during its operation in a seal for rotating joints for example. Lips 2a and 2b are advantageously dimensioned, meaning that they are smaller than the heel so that, when they are combined with the appropriate material, the said lips are elastic, meaning that they are capable of exerting a sufficient springback force to recover an resting configuration.

Preferably, the material used for the manufacture of the seal 1 according to the invention can be polyetheretherketone (henceforth referred to as PEEK). PEEK is a semi-crystalline thermoplastic polymer that has very good physiochemical properties: a high melting point of around 343° C., a very good chemical resistance to solvents and various chemical compounds, a good mechanical resistance with a ductile material and a Young's modulus of around 3.6 GPa. The Young's modulus, also called modulus of elasticity, is the constant that links the tensile (or compression) stress and the deformation for an isotropic elastic material. A material that has a very high Young's modulus is called rigid: PEEK is therefore considered to be a rather elastic material. The derivatives of PEEK can be, by way of non-limiting examples, carbon-filled PEEK or carbon nanotube-filled PEEK.

Alternatively, the thermoplastic polymer may advantageously be polyamide-imide (henceforth referred to as PAI), an amorphous thermoplastic polymer, which has exceptional thermal, physical and chemical properties. It has very high levels of resistance to chemical products, wear, irradiation and heavy loads. Its Young's Modulus is about 4 to 5 GPa: like PEEK, PAI is regarded as a material with low-rigidity.

The seal 1 according to the invention can advantageously comprise one or more grooves 6 in the heel. The said grooves 6 correspond to narrow undercuts, usually rounded at the bottom. They are advantageously machined in the heel so that the contact pressure of the said seal 1 is greater than the pressure of the fluid to be sealed in order to ensure optimum sealing of the seal 1, sealing being possible round the diameter or on the face.

Advantageously, the U-section of the seal 1 has a rotational symmetry in relation to the median plane (M) of the heel. This preferred U-shaped section, particularly when the seal 1 is used in a rotating shaft, allows the seal to be used in different configurations depending on the groove or surface to be sealed.

Lastly, two methods of manufacturing the seal 1 according to the invention can be performed. These different methods depend on the application or use envisaged for the seal 1, and consequently on the diameter of the seal 1.

Firstly, in a preferred but non-limiting way, the method of manufacturing the seal according to the invention may include a machining step. The principle of machining is to remove material so as to give the raw part the desired shape and dimensions, with the aid of a machine tool. The various types of machining include, by way of non-limiting examples: boring, broaching, milling, drilling, threading, tapping or laser cutting.

Alternatively or additionally, the method of manufacturing a seal according to the invention may include an injection-moulding step. Moulding allows thermoformable materials to be used, notably thermoplastics materials. The plastics material takes the form of powders or granules: as a first step it is heated and thermoregulated, then injected at high pressure into a mould or cavity having the shape of the desired part during a phase called the “filling phase”; lastly, a constant pressure is applied for a fixed time in order to alleviate shrinkage of the material as it cools. The part is cooled for a few seconds then ejected. A new cycle can then begin.

FIGS. 3a and 3b show two configurations of a seal according to the invention.

In the two examples proposed, the seal 1 has an annular shape, advantageously configured with respect to its use. In effect, the preferred application is to use the seal 1 to ensure sealing in rotating joints. In effect, use in rotating joints requires dynamic sealing, meaning that the sealing surfaces are mobile. As the type of movement between the parts is rotation, the movement is usually perpendicular to the pressure gradient.

Furthermore, two classes of sealing should be distinguished: radial sealing where the sealing surface is cylindrical, and axial sealing where the sealing surface is perpendicular to the axis of rotation. These two classes of sealing require two different configurations as described in connection with FIGS. 3a and 3b. According to FIG. 3a, the lips 2a and 2b of the seal according to the invention are in an axial position: “axial position” means that the lips 2a and 2b are projecting parallel to the rotational axis R of the said seal. According to FIG. 3b, the lips 2a and 2b of the seal 1 according to the invention are in a radial position: “radial position” means that the lips 2a and 2b project in a plane perpendicular N to the rotational axis R. The different configurations described in connection with FIGS. 3a and 3b are used in rotating joints, namely in “piston” or “face” assemblies.

FIGS. 4a to 4d show a variation of application of a seal 1 in rotating shafts or rotating joints, as well as the preferred assemblies for using the seal according to the invention.

A rotating joint, also commonly called a swivel union, is a mechanical part serving to convey different liquid or gaseous fluids from a fixed part to a mechanical element that is moving, more specifically rotating. The function of a rotating joint is to ensure a leak-free connection to carry a fluid between fixed supply points and rotating or oscillating reception points. Rotating joints are used in numerous applications, these applications dependant on the diameter of the seals. They are in particular used in offshore rigs in connection with oil containment systems for example.

By way of a preferred but non-limiting example described in connection with FIG. 4a, the rotating joint 10 according to the invention can consist of a fixed part 7 and a rotating part 8, both kept concentric by a mechanical bearing 9, and a toroidal chamber (not shown in the Figure) formed between the fixed 8 and rotating 8 parts. One or more seals 1 can cooperate with the fixed 7 and rotating 8 parts.

Different configurations can be performed depending on the use of the rotating joint 10. These include, by way of non-limiting examples, “piston” and “face” assemblies. These assemblies are described in connection with FIGS. 4b to 4d. Preferably, a seal 1 according to the invention is used to ensure sealing between a rotating part 8 and a fixed part 7. The said seal 1 is placed in a groove 12 and can ensure sealing between the rotating part 8 and the fixed part 7, either on a surface adjacent to one of the lips 2a and 2b, or on a surface adjacent to the heel 5. FIG. 4b shows the use of the seal 1 according to the invention when it is implemented in a “piston” assembly. Sealing is ensured thanks to the lips 2a and 2b on the rotating part 8 and the fixed part 7. FIG. 4c shows the use of the seal 1 according to the invention when it is implemented in a “face” assembly. Sealing is ensured thanks to lips 2a and 2b between the rotating part 8 and the fixed part 7. FIG. 4d shows the use of the seal 1 according to the invention when it is implemented in a “piston” assembly. Sealing is ensured thanks to the heel 5 on the rotating part 8 and the fixed part 7.

FIG. 5 shows another variation of use of the seal 1 incorporated in friction bearings and washers.

A friction bearing is an element used to support and guide, in rotation, one part in relation to another, and more specifically a transmission shaft. Depending on the desired use, several categories of bearings can be distinguished:
plain bearings: the parts, resting on bushes, are subject to sliding friction between the surfaces in contact;
roller bearings: the contact between the different parts is achieved by means of balls or rollers contained in cages. This phenomenon of rolling friction allows a higher load on the bearings and a faster speed of rotation.
   The friction bearing is inserted in a female part; a male part is rotating inside. The operating clearance between the bearing and the male part is smaller than the clearance between the female part and the male part so as to prevent any contact between the two parts. Preferably, the friction bearing is made of an antifriction material, different from the moving parts that it supports and guides, the said material having the lowest possible friction coefficient and possibly requiring a lubrication system. One or more, for example two, seals 1 according to the invention can be integrated or incorporated directly into the bearing 11 or friction washer in order to ensure sealing and the protection, particularly against wear, of the friction surfaces. The materials considered for the seal, more particularly PEEK and PAI, are self-lubricating. In a preferred but non-limiting way, the same materials will be used for the friction bearing or washer. The friction bearing and the seal or seals 1 according to the invention form a single entity.

The invention has been described during its operation in relation to rotating shafts to ensure sealing thereof. It can also be used for all types of dynamic sealing, more particularly those involving any relative movement including a rotation.

It could also be considered that the seal comprises three, four or an even higher number of lips. Similarly, it could also be considered that a plurality of seals or friction bearings are connected in series or in parallel in order to improve sealing efficiency.

Other modifications can be considered without departing from the scope of the present invention defined by the accompanying claims.

1. A seal, comprising a first flexible lip cooperating with a heel and having, when said first lip is in a resting configuration, a U section, wherein the heel and the first lip consist mainly of a chemically neutral and mechanically resistant thermoplastic polymer or of one of the derivatives thereof, and the said first lip is arranged in order to exert a springback force sufficient to recover the resting configuration.

2. The seal according to claim 1, comprising a second flexible lip arranged so as to exert a springback force sufficient to recover a resting configuration and the U section of the said seal having a rotational symmetry in relation to the median plane of the heel.

3. The seal according to claim 1, wherein the thermoplastic polymer is polyetheretherketone (PEEK).

4. The seal according to claim 3, wherein the thermoplastic polymer is carbon-filled.

5. The seal according to claim 1, wherein the thermoplastic polymer is polyamide-imide (PAI).

6. The seal according to claim 1, wherein the seal has an annular shape.

7. The seal according to claim 1, wherein the heel also comprises one or more grooves arranged in the distal part of said heel opposite the lips.

8. The seal according to claim 1, wherein the lip is in a radial position.

9. The seal according to claim 1, wherein the lip is in an axial radial position.

10. The seal according to claim 1, wherein the heel and the lip form a single entity.

11. Manufacturing process of a seal according to claim 10, comprising a machining step of the seal.

12. Manufacturing process of a seal according to claim 10, comprising an injection-moulding step of the said seal.

13. A rotating joint, comprising a fixed part and a rotating part kept concentric by a mechanical bearing, a toroidal chamber formed between the said fixed and rotating parts, arranged to form a limited passage of fluid, wherein the toroidal chamber contains at least one seal defined according to claim 1.

14. A friction bearing, comprising one or more seals according to claim 1.
